(19) United States
(12) Patent Application Publication
(10) Pub. No.: US 2002/0067477 A1
(43) Pub. Date: Jun. 6, 2002

(54) Patten inspection apparatus, and exposure apparatus control system using same

(76) Inventors: Masayuki Morita, Saitama (JP); Hitoshi Tamada, Kanagawa (JP); Yutaka Imai, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/934,908

(22) Filed: Aug. 22, 2001

(30) Foreign Application Priority Data
Aug. 23, 2000 (JP) P2000-252896

(51) Int. Cl. G01N 21/88

(52) U.S. Cl. 356/237.5

(57) ABSTRACT

A pattern inspection apparatus 7 is incorporated in a semiconductor production line 1 for lithography. The pattern inspection apparatus 7 measures the line width of both an isolated pattern and that of an L/S pattern, formed on a semiconductor wafer 100 through an exposure process in an exposure apparatus 4, and generates light-amount corrective information intended for use to correct the amount of light in the exposure apparatus 4, focus corrective information intended for use to correct the exposure focus position, etc. based on the result of the measurement. Then, the exposure in the exposure apparatus 4 is corrected correspondingly to these corrective information generated by the pattern inspection apparatus 7. Thus, a resist pattern formed by the exposure apparatus 4 can be inspected speedily to permit a real-time correction of parameters of the exposure apparatus 4 on the basis of the result of inspection and control the parameters of the exposure apparatus 4 with a high accuracy.

### BACKGROUND OF THE INVENTION

1. Field of the Invention

The present invention relates to a pattern inspection apparatus to inspect a fine pattern formed on a semiconductor wafer and an exposure apparatus control system to control an exposure apparatus used in a lithography included in a semiconductor producing process.

2. Description of the Related Art

For finer patterns of the semiconductor circuits in the recent field of this art, the controlled value of the critical-dimensional (CD) line width required for the lithography is going beyond the control limit of the exposure apparatus used in the lithography. The CD line width is an extremely important factor for determining the basic performance of a semiconductor integrated circuit, and in the lithography included in the semiconductor producing process, the improvement of production yield greatly depends upon how the CD line width is controlled.

It is well known that in the lithography, the CD line width is determined various parameters including an amount of light used in the exposure apparatus, exposure focus position, projection lens aberration, image field curvature, image field inclination, etc. Therefore, for controlling the CD line width, it is important to control these parameters in the exposure apparatus stably and with a high accuracy.

Generally, to stably control the parameters in the exposure apparatus, the line width of a resist pattern formed by the use of the exposure apparatus is measured using a scanning electron microscope (SEM) or the like and the result of measurement is fed back to the exposure apparatus to keep the parameters in the exposure apparatus at optimum levels, respectively. That is, if the line width of the resist pattern formed by the exposure apparatus is deviated from a desired one, the exposure apparatus can be controlled for the desired line width of the resist pattern by feeding the deviation as corrective information back to the exposure apparatus and correcting the parameters in the exposure apparatus correspondingly to the corrective information fed back to the latter.

However, the speed of the measurement using the SEM or the like is extremely slower than that the operation speed of the exposure apparatus normally used in the lithography. Hence, when the result of measurement obtained using the SEM or the like is fed back to the exposure apparatus to correct the parameters in the latter, the time constant is so slow that no real-time operations can be done.

Recently, it has been actively made to develop a laser microscope using a laser light having a single wavelength as an illumination light. As an apparatus to measure the line width of a resist pattern formed by the exposure apparatus, it has been tried to use such a laser microscope as an inspection apparatus. Using a short-wave deep-ultraviolet (UV) laser as a light source of the laser microscope, the inspection apparatus can have a sufficient optical resolution for a highly accurate measurement of the line width of the recent finer resist pattern.

The inspection apparatus using such a laser microscope can operate considerably faster than a conventional one using the SEM or the like and at an approximately same speed of the exposure apparatus which is used to form the resist pattern. Therefore, such an exposure apparatus can be used to measure the line width of the formed resist pattern at the same speed as that of the resist pattern forming by the exposure apparatus and make real-time correction of parameters in the exposure apparatus.

For effective use of the inspection apparatus incorporating such a laser microscope to measure the line width of a resist pattern, it is desired to univocally determine an amount of correction for each of the parameters in the exposure apparatus. That is, if the line width of the resist pattern measured using the inspection apparatus is found deviated from a desired one and it is possible to know which one of the parameters in the exposure apparatus has caused the deviation, the parameter in question in the exposure apparatus can properly be corrected by feeding the deviation as corrective information back to the exposure apparatus.

### OBJECT AND SUMMARY OF THE INVENTION

It is therefore an object of the present invention to overcome the above-mentioned drawbacks of the prior art by providing a pattern inspection apparatus which can inspect a resist pattern formed by an exposure apparatus to permit a real-time correction of a parameter in the exposure apparatus while univocally determining a deviation of the parameter of the exposure apparatus on the basis of the result of inspection to permit a highly accurate control of the parameter of the exposure apparatus, and an exposure apparatus control system which uses the pattern inspection apparatus to control the exposure apparatus.

The above object can be attained by providing a pattern inspection apparatus which optically inspect a resist pattern formed on a semiconductor wafer correspondingly to a patten of a semiconductor circuit going to be produced, the apparatus including means for measuring at least both the line width of an isolated pattern being a convex pattern and that of a repeated pattern in which a convex pattern and concave one are repeated in a predetermined cycle, and means for generating corrective information intended for use to correct the exposure by an exposure apparatus used to form the resist pattern on the basis of the line width of the isolated pattern and that of the repeated pattern, having been measured by the above measuring means. In the pattern inspection apparatus, the corrective information generating means separates exposure condition error information of the exposure apparatus, obtained from a line width error of the isolated pattern and that of the repeated pattern, into an light-amount error component and an exposure focus position error component to generate light-amount corrective information intended for use to correct the amount of light and focus corrective information intended for use to correct the exposure focus position.

In the above pattern inspection apparatus according to the present invention, the measuring means is adapted to measure at least both the line width of an isolated pattern being an single isolated convex pattern and that of a repeated pattern in which a convex pattern and concave pattern are repeated in a predetermined cycle. The corrective information generating means is adapted to generate corrective information intended for use to correct the exposure by the exposure apparatus used to form a resist pattern on the basis of the line width of the isolated pattern and that of the repeated pattern, having been measured by the measuring means.

At this time, a line width error of the isolated pattern, that is, a deviation of the isolated pattern line width measured by the measuring means from a predetermined one, and a line width error of the repeated pattern, that is, a deviation of the repeated pattern line width measured by the measuring means, are recognized as exposure condition error information for the exposure apparatus. The corrective information generating means separates the above exposure condition error information into a light-amount error component and an exposure focus position error component to generate light-amount corrective information intended for use to correct the amount of light, and focus corrective information intended for use to correct the exposure focus position.

The light-amount corrective information and focus corrective information will be supplied to the exposure apparatus. In the exposure apparatus, the amount of light will be corrected correspondingly to the light-amount corrective information supplied from the pattern inspection apparatus, and thus the exposure focus position will be corrected correspondingly to the focus corrective information.

Also, the above object can be attained by providing an exposure apparatus control system including an exposure apparatus used to form a resist pattern on a semiconductor wafer correspondingly to a pattern of a semiconductor circuit going to be produced, and a pattern inspecting apparatus to optically inspect the resist pattern formed on the semiconductor wafer by the exposure apparatus. In the exposure apparatus control system, the pattern inspection apparatus includes means for measuring at least both the line width of an isolated pattern being a convex pattern and that of a repeated pattern in which a convex pattern and concave one are repeated in a predetermined cycle, and means for generating corrective information intended for use to correct the exposure by an exposure apparatus used to form the resist pattern on the basis of the line width of the isolated pattern and that of the repeated pattern, having been measured by the above measuring means, the corrective information generating means separates exposure condition error information of the exposure apparatus, obtained from a line width error of the isolated pattern and that of the repeated pattern, into an light-amount error component and an exposure focus position error component to generate light-amount corrective information intended for use to correct the amount of light and focus corrective information intended for use to correct the exposure focus position. In the exposure apparatus, the amount of light is corrected correspondingly to the light-amount corrective information generated by the corrective information generating means included in the pattern inspection apparatus and the exposure focus position is corrected correspondingly to the focus corrective information generated by the corrective information generating means included in the pattern inspection apparatus.

In the exposure apparatus control system, information of exposure error in the exposure apparatus, obtained in the pattern inspection apparatus from the deviations of the isolated pattern line width and repeated pattern line width, is separated into a light-amount error component and exposure focus error component to generate light-amount correction error intended for use to correct the amount of light and focus corrective information intended for use to correct the exposure focus position, and thus the amount of exposure light in the exposure apparatus is corrected correspondingly to the light-amount corrective information while the exposure focus position in the exposure apparatus is corrected correspondingly to the focus corrective information, whereby the exposure in the exposure apparatus can properly be controlled.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 is an example of the construction of a semiconductor production line using the exposure apparatus control system according to the present invention;

FIG. 2 is a schematic diagram of the pattern inspection apparatus according to the present invention;

FIG. 3 shows the relation between line widths of an isolated pattern and L/S pattern, measured by the pattern inspection apparatus, and amount of exposure light in the exposure apparatus;

FIG. 4 shows the relations between the line widths of the isolated and repeated patterns, measured by the pattern inspection apparatus, and exposure focus position in the exposure apparatus, in which FIG. 4A shows the relation between the line width of the isolated pattern and exposure focus position and FIG. 4B shows the relation between the line width of the L/S pattern and exposure focus position;

FIG. 5 explains how to measure the line width of the isolated pattern from its image in the pattern inspection apparatus;

FIG. 6 explains how to measure the line width of the L/S pattern from its image in the pattern inspection apparatus;

FIG. 7 explains how to measure the line width of the L/S pattern from its image in the pattern inspection apparatus, in which FIG. 7A is a plan view of an example of an inspection pattern formed on a semiconductor wafer and FIG. 7B shows the relation between the optical modulation obtained from the image of the L/S pattern and a pattern duty;

FIG. 8 shows an example of a spatial filter beam-limiter which provides a deformed illumination in the pattern inspection apparatus;

FIG. 9 shows the relation between the line width of the isolated pattern, measured by the pattern inspection apparatus, and a bottom line width measured by the SEM, together with the relation between the line widths and the exposure focus position in the exposure apparatus;

FIG. 10 shows the relation between the focus position in the pattern inspection apparatus, from which a best contrast point of a diffracted interference image of the isolated pattern, and the line width of the latter;

FIG. 11 explains an algorithm used in the pattern inspection apparatus for determination of a line width of the L/S pattern, line width of the isolated pattern, defocused amount and defocused direction in the exposure apparatus; and

FIG. 12 explains how to inspect, by the pattern inspection apparatus, the accuracy of registration of the isolated pattern on an isolation pattern on the basis of an image of the isolated and isolation patterns registered one on the other.

### DETAILED DESCRIPTION OF THE PREFERRED EMBODIMENTS

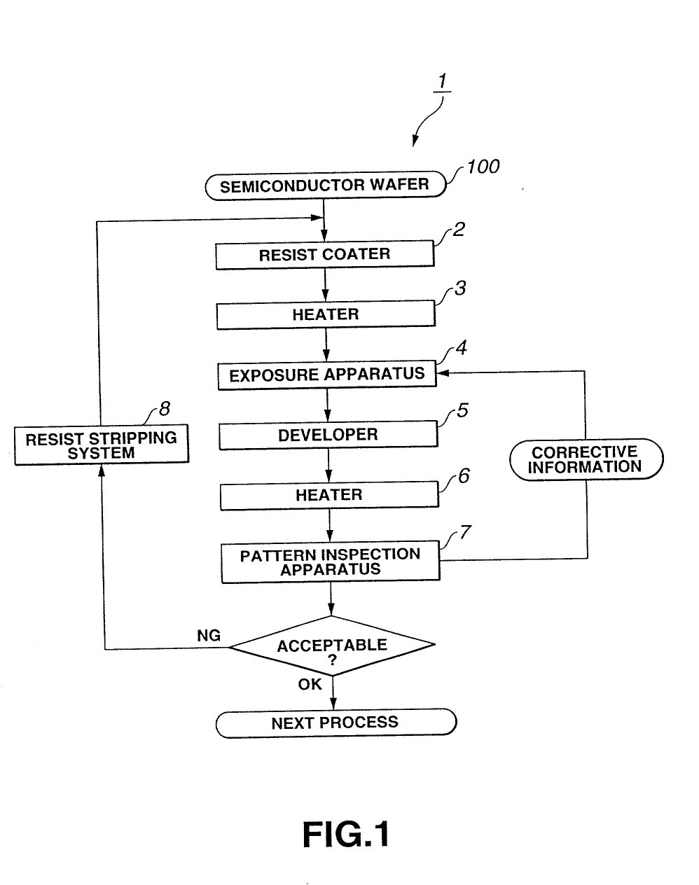

Referring now to FIG. 1, there is schematically illustrated an example of the construction of a semiconductor production line using the exposure apparatus control system according to the present invention. As shown in FIG. 1, the semiconductor production line generally indicated with a reference 1 is a series of production lines in which a lithography included in a process of semiconductor production. The semiconductor production line 1 includes a resist coater 2, heater 3, exposure apparatus 4, developer 5, heater 6, pattern inspection apparatus 7 and a resist stripping system 8, incorporated in line with each other.

In the semiconductor production line 1, a semiconductor wafer 100 is first supplied to the resist coater 2. The resist coater 2 coats the supplied semiconductor wafer 100 with a resist material. Thus, a resist layer will be formed on the semiconductor wafer 100.

The semiconductor wafer 100 having been coated with the resist material by the resist coater 2 and thus the resist layer formed thereon is next supplied to the heater 3. The heater 3 pre-bakes the resist layer on the supplied semiconductor water 100. Thus, the residual solvent in the resist layer is volatilized to increase the adhesion of the resist layer to the semiconductor wafer 100.

The semiconductor wafer 100 pre-baked by the heater 3 is next supplied to the exposure apparatus 4. In the exposure apparatus 4, a pattern reticle corresponding to a pattern of a semiconductor circuit going to be produced is used to expose the resist layer formed on the semiconductor wafer 100 to a light, whereby a pattern latent image corresponding to the semiconductor circuit pattern will be formed in the resist layer on the semiconductor wafer 100.

The semiconductor wafer 100 having the resist layer thereof exposed to a light by the exposure apparatus 4 is next supplied to the developer 5. The developer 5 develops the resist layer exposed by the exposure apparatus 4. When excess resist has been removed from the resist layer developed in the developer 5, a resist pattern corresponding to the intended semiconductor circuit pattern will be formed on the semiconductor wafer 100.

The semiconductor wafer 100 having the resist pattern formed thereon after the development by the developer 5 is next supplied to the heater 6. The heater 6 post-bakes the resist pattern in the supplied semiconductor wafer 100. The post-baking is intended to improve the etching resistance, thermal resistance and the like of the resist pattern.

The semiconductor wafer 100 having been subjected to the post-baking in the heater 6 is next supplied to the pattern inspection apparatus 7. The pattern inspection apparatus 7 adopts a laser microscope for use to optical inspect the resist pattern on the supplied semiconductor wafer 100. More particularly, the pattern inspection apparatus 7 measures for example the line width of an isolated pattern being an isolated convex pattern, line width of a repeated pattern in which a convex pattern and concave pattern are repeated in a predetermined cycle (the repeated pattern will be referred to as “L/S (line and space pattern) pattern” hereunder, accuracy of registration of the isolated pattern on an isolation pattern formed as a primary layer of the isolated pattern, diameter and depth of a contact hole, etc. Also, the pattern inspection apparatus 7 inspects a distortion, magnification factor, image field curvature and image field inclination in the exposure apparatus 4.

In the semiconductor production line 1, it is judged based on the results of inspections made in the pattern inspection apparatus 7 whether the resist pattern having been formed on the semiconductor wafer 100 is acceptable or not. Only a semiconductor wafer 100 judged to have an acceptable resist pattern is fed as an acceptable wafer to a next process. On the other hand, a semiconductor wafer 100 whose resist pattern has been judged to be rejectable is supplied as a rejectable wafer to the resist stripping system 8.

The resist stripping system 8 strips and washes the resist pattern from on the semiconductor wafer 100 having been judged to have a rejectable resist pattern, whereby the semiconductor wafer 100 is rendered to its state before it has been coated with the resist material. The semiconductor wafer 100 from which the resist pattern has thus been stripped is supplied again to the resist coater 2 by which a resist pattern will be formed again on the semiconductor wafer 100.

As in the above, in the semiconductor production line 1, various units to form a resist pattern on a semiconductor wafer 100 are disposed in line with the pattern inspection apparatus 7 which is provided to inspect the resist pattern, and all semiconductor wafers 100 each having a resist pattern formed thereon are inspected. Thus, rejectable wafers are subjected to a next process and acceptable wafers are subjected to the resist pattern re-forming process, both with a considerably low frequency.

That is, in the resist pattern inspection conducted in the conventional lithography, the SEM or the like is generally used in the inspection apparatus. Since the resist pattern is inspected at a considerably slower speed than the resist pattern forming speed, not all the semiconductor wafers can be inspected, and so arbitrary ones are extracted from a plurality of semiconductor wafers for the purpose of inspection and the resist patterns are judged in a statistic manner. Thus, a lot of semiconductor wafers having been judged to be acceptable is totally fed to the resist pattern re-forming process and so acceptable semiconductor wafers are also subjected to the resist pattern re-forming process as the case may be. Also, a lot of semiconductor wafers including rejectable ones is judged to be acceptable and fed to a next process in some cases.

However, the pattern inspection apparatus 7 included in the semiconductor production line 1 is a one using a laser microscope and which can work at a relatively high speed is used as the pattern inspection apparatus. The pattern inspection apparatus 7 is incorporated in line with other units which are provided to form a resist pattern on a semiconductor wafer 100, and all the semiconductor wafers 100 each having a resist pattern formed thereon are subjected to the inspection. Therefore, only the acceptable semiconductor wafers can be supplied to a next process very efficiently and properly without the above-mentioned inconveniences.

Also, in this semiconductor production line 1, the pattern inspection apparatus 7 is adapted to inspect the resist pattern on each supplied semiconductor water 100 and generate, and feed back to the exposure apparatus 4, corrective information intended for use to correct the exposure in the exposure apparatus 4 on the basis of the result of inspection. Thus the exposure in the exposure apparatus 4 is corrected correspondingly to the corrective information, whereby the exposure apparatus 4 is controlled.

Now, an embodiment of the pattern inspection apparatus 7 provided to inspect the resist pattern formed on the semiconductor wafer 100 will be described in detail below.

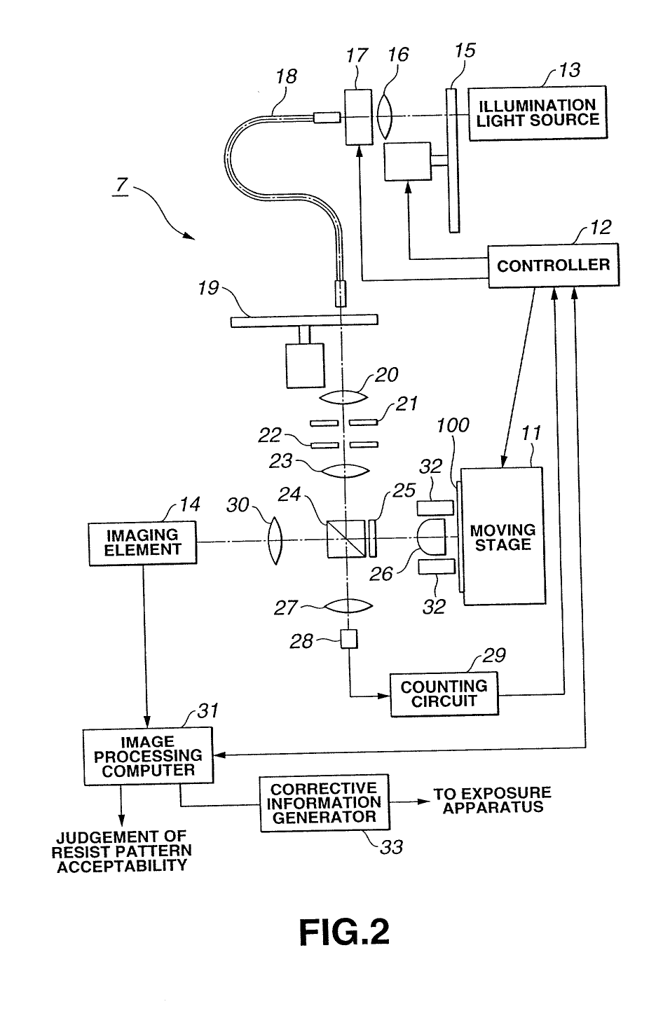

The pattern inspection apparatus 7 is adapted to pick up an image of a resist pattern formed on the semiconductor wafer 100 by the use of a laser microscope and inspect the resist pattern based on the picked-up image of the resist pattern. As shown in FIG. 2, the pattern inspection apparatus 7 includes for example a moving stage 11 which supports the semiconductor wafer 100 movably to an arbitrary position.

The moving stage 11 includes for example an X,Y stage provided to horizontally move a semiconductor wafer 100 placed on the moving stage 11, a Z stage to move the semiconductor wafer 100 vertically, a φ stage to rotate the semiconductor wafer 100, and a suction plate to suck and fix the semiconductor wafer 100. The moving stage 11 is adapted such that each of the stages thereof can be moved under the control of a controller 12. As each stage is moved, the semiconductor wafer 100 sucked by the suction plate can be moved at an arbitrary portion thereof to be inspected to a predetermined inspection position in the pattern inspection apparatus 7 and adjusted in height properly, to thereby adjust the focusing optimally for inspection.

Also, the pattern inspection apparatus 7 includes an illumination light source 13 which emits an illumination light to an arbitrary portion of the semiconductor wafer 100 positioned at a predetermined location.

As the illumination light source 13, an ultraviolet laser source should preferably be used which can emit a UV laser having a wavelength of 150 to 370 nm. More specifically, the illumination light source 13 should preferably use any one of a total solid-state laser with the YAG fourth harmonic and of 266 nm in wavelength, a near infrared laser with the YAG fourth harmonic and of about 710 to 740 nm, a total solid-state laser with a sum frequency extracted by the user of a titanium-sapphire crystal, KrF excimer laser, ArF excimer laser, Fe excimer laser and the like.

Using a UV laser source which emits such a short-wave UV laser light as the illumination light source 13, the pattern inspection apparatus 7 can inspect the resist pattern formed on the semiconductor wafer 100 with a high resolution.

The pattern inspection apparatus 7 also includes an illumination optical system which radiates a UV laser light emitted from the illumination light source 13 to a resist pattern formed on the semiconductor wafer 100 and thus illuminates the resist pattern, and an imaging optical system which guides a reflected light, scattered light, diffracted light, etc. from the resist pattern illuminated by the UV laser light to an imaging element 14 to form an image of the resist pattern on the imaging element 14.

Each of optical elements forming together these illumination and imaging optical systems will be described below with reference to FIG. 2. A UV laser light emitted from the illumination light source 13 is first transmitted through a variable ND filter (beam attenuation filter) 15 and incident upon a condenser lens 16. The variable ND filter 15 is to attenuate the UV laser light emitted from the illumination light source 13 without changing its spectral composition.

The UV laser light incident upon the condenser lens 16 is condensed by the latter and focused inside a shutter 17. The shutter 17 consists of an acoustic optics modulator (AOM) or the like for example to make a selection between transmission and cutoff of the UB laser light under the control of the controller 12. The AOM utilizes the acousto-optical effect and can freely modulate a diffracted light within the range of diffraction efficiency. By cutting off a zero-order diffracted light from the AOM and extracting only a first-order diffracted light by a spatial filter, it is possible to build a highly responsive shutter. With a selection made between transmission and cutoff of the UV laser light by the shutter 17, the amount of the UV laser light transmitted through the shutter 17 will be adjusted and the amount of the UV laser light radiation to an inspection portion of the semiconductor wafer 100 is adjusted.

When the pattern inspection apparatus 7 is used to inspect the resist pattern on the semiconductor wafer 100, a UV laser light having a wavelength approximate to the exposure wavelength will be radiated to the resist pattern. So, to prevent the resist pattern from being shrunk, it is important to control the amount of UV laser light radiation. For this reason, in the pattern inspection apparatus 7, the shutter 17 is provided in the optical path of the UV laser light. As the shutter 17 makes a selection between transmission and cutoff of the UV laser light under the control of the controller 12 to adjust the amount of UV laser light radiation.

It should be noted that the shutter 17 may be of any type which could make a selection between transmission and cutoff of the UV laser light emitted from the illumination light source 13. For example, the shutter 17 may be a spatial optical modulation such as a liquid crystal panel made of a liquid crystal material, light diffraction type shutter using a diffraction grating or a waveguide type shutter utilizing the photoelasticity effect.

The UV laser light transmitted through the shutter 17 is radiated to a diffusing surface of a rotating diffusion plate 19 through an optical fiber 18. Note that the optical fiber 18 is provided to flexibly guide the UV laser light emitted from the illumination light source 13 to each of optical elements provided downstream of the illumination light source 13 while randomizing the deflected direction of a linearly polarized UV laser light emitted from the illumination light source, thereby converting a single mode of the incident UV laser light to a multiple mode. Also, the rotating diffusion plate 19 is provided to reduce speckle noise which will be problem when a highly coherent UV laser light is used as an illumination light. Both the optical fiber 18 and rotating diffusion plate 19 work as a coherency reducing means to reduce the coherency of the illumination optical system to provide a uniform illumination.

The UV laser light radiated to the rotating diffusion plate 19 is sequentially transmitted through a condenser 20, aperture stop 21, field stop 22 and a condenser lens 23, which form together a Koehler illumination system using the rotating diffusion plate 19 as a light source, and incident upon a polarization beam splitter 24.

The UV laser light incident upon the polarization beam splitter 24 is split by the polarization beam splitter 24 into two linearly polarized light components taking directions perpendicular to each other, one of which will be reflected by the polarization beam splitter 24 while the other will be transmitted through the polarization beam splitter 24.

The one of the linearly polarized light components, reflected by the polarization beam splitter 24, is allowed to pass through a ¼ wave plate 25 and thus circularly polarized, and radiated to the resist pattern on the semiconductor wafer 100 through an objective lens 26. Thus, the resist pattern on the semiconductor wafer 100 will be illuminated by the UV laser light. In the pattern inspection apparatus 7, the optical elements including from aforementioned variable ND filter 15 to the objective lens 26 form together the illumination optical system.

Also, the other linearly polarized light component transmitted through the polarization beam splitter 24 is incident upon a light-amount monitor 28 through an imaging lens 27, and detected by the light-amount monitor 28. Note that the other linearly polarized light component transmitted through the polarization beam splitter 24 and detected by the light-amount monitor 28 is proportional to the one linearly polarized light component reflected by the polarization beam splitter 24 and radiated to the resist pattern on the semiconductor wafer 100 on the assumption that the dependence of the illumination light source 13 on the polarization is constant. Therefore, by determining the mutual relation between these linearly polarized light components in advance, it is possible to determine an amount of UV laser light radiation to the resist pattern on the semiconductor wafer 100 from the other linearly polarized light component detected by the light-amount monitor 28.

As the light-amount monitor 28 to monitor the amount of UV laser light radiation, for example a CCD (charge-coupled device) camera for ultraviolet light, adapted to be highly sensitive to a deep-ultraviolet laser light, may be used. The light-amount monitor 28 is connected to a counting circuit 29, converts a detected light to an electric signal and supplies it to the counting circuit 29. Calculating an integrated amount of radiated UV laser light from the electric signal supplied from the light-amount monitor 28, the counting circuit 29 supplies it to the controller 12

Note that the light-amount monitor 28 may be of any type which could convert a detected light to an electric signal. For example, a phototransistor, calorimeter or the like may be used as the light-amount monitor 28.

In the pattern inspection apparatus 7, the controller 12 is adapted to control the shutter 17 correspondingly to an integrated amount of UV laser light, calculated by the counting circuit 29, to adjust the amount of UV laser light radiation to the resist pattern on the semiconductor wafer 100. More specifically, as the integrated amount of UV laser light radiation, calculated by the counting circuit 29, becomes approximate to a radiation threshold which will cause the resist pattern to be shrunk, the controller 12 will close the shutter 17 to cut off the UV laser light so that the UV laser light will not be radiated to the resist pattern. Also, the controller 12 can adjust the amount of UV laser light radiation to the resist pattern by controlling the variable ND filter 15.

Also, in the pattern inspection apparatus 7, the controller 12 can put the shutter 17 included in the illumination optical system into synchronization with the shutter of the imaging element 14 consisting of an ultraviolet CCD camera in order to control opening and closing of the shutter 17. Thus, by controlling opening and closing of the shutter 17 in the illumination optical system synchronously with the shutter of the imaging element 14, it is possible to efficiently radiate the UV laser light to the resist pattern on the semiconductor wafer 100.

The UV laser light radiated to the resist pattern on the semiconductor wafer 100 will be reflected, scattered and diffracted correspondingly to a state of the resist pattern. The reflected light, scattered light and diffracted light from the resist pattern are transmitted through the objective lens 26, and incident upon the ¼ wave plate 25 through the objective lens 26. The light is converted by the ¼ wave plate 25 to a circularly polarized one and then incident upon the polarization beam splitter 24 again. Note that each of the reflected light, scattered light and diffracted light from a portion, under inspection, of the semiconductor wafer 100, having been incident upon the polarization beam splitter 24, is a linearly polarized one perpendicular to the linearly polarized light previously reflected by the polarization beam splitter 24, and so ti will be allowed to pass through the polarization beam splitter 24.

The reflected light, scattered line and diffracted light from the inspected portion of the semiconductor wafer 100, having been transmitted through the polarization beam splitter 24, are incident upon the imaging element 14 through an imaging lens 30. Thus, an image of the resist pattern, magnified by the objective lens 26, will be picked up by the imaging element 14.

In the pattern inspection apparatus 7, the optical elements including from the objective lens 26 to the imaging lens 30 form together the imaging optical system.

Note that the objective lens 26 is a one having a large numerical aperture (NA) of about 0.9. Using a short-wave UV laser light as the illumination light and a large-NA lens as the objective lens 26, the pattern inspection apparatus 7 can inspect fine patterns with a high efficiency. Also, the objective lens 26 is adapted to reduce the aberration against a UV laser light as the illumination light.

Also, the imaging element 14 is for example a high-sensitivity ultraviolet CCD camera which can assure a high quantum efficiency to the UV laser light, more particularly, a quantum efficiency of about 36% for example. By using a CCD camera highly sensitive to the UV laser light as the imaging element 14, it is possible to image a fine pattern with a high resolution. The imaging element 14 is connected to an image processing computer 31. In the pattern inspection apparatus 7, an image of the resist pattern on the semiconductor wafer 100, picked up by the imaging element 14 is taken into the image processing computer 31.

Note that the imaging element 14 should desirably be provided with a cooling feature. For example, in case an ultraviolet CCD camera is used as the imaging element 14, the CCD chip should desirably be constructed so as to be cooled down to about 5° C. By cooling the imaging element 14 in this way, it is possible to considerably suppress reading noise and thermal noise, which will take place when an image of the resist pattern on the semiconductor wafer 100, picked up by the imaging element 14, is transferred to the image processing computer 31.

The pattern inspection apparatus 7 includes also a focus controller which adjusts the distance between the objective lens 26 and the semiconductor wafer 100 under inspection, that is, the focusing of the imaging optical system.

In the conventional pattern inspection apparatus using an optical microscope, an illumination light is radiated to an object under inspection, and a reflected light from the object is detected to measure the distance between the objective lens and object, thereby adjusting the focusing. However, adjusting the focusing while the illumination light is being radiated to the object will lead to counting of the illumination light also as an amount of illumination light radiation to the object under inspection. If the adjustment of the focusing leads to such a counting of the amount of illumination light radiation, the amount of illumination light radiation in the practical inspection will be limited. That is, the inspection by this inspection apparatus is very poor in efficiency.

To avoid the above, in the pattern inspection apparatus 7, a capacitance type sensor 32 is disposed near the objective lens 26 to detect the distance between the objective lens 26 and a semiconductor wafer 100 under inspection, and the focusing of the imaging optical system is adjusted by driving the Z stage of the moving stage 11 by the controller 12 until the distance between the objective lens 26 and semiconductor wafer 100 becomes optimum. That is, in the pattern inspection apparatus 7, the capacitance type sensor 32, controller 12 and the Z stage of the moving stage 11 function to adjust the focusing of the imaging optical system.

In the pattern inspection apparatus 7, an image of the resist pattern on the semiconductor wafer 100, picked up by the imaging element 14, is supplied to the image processing computer 31 which processes and analyzes the supplied image to inspect the resist pattern.

More specifically, the pattern inspection apparatus 7 images an isolated pattern formed as an isolated convex on the semiconductor wafer 100 and generates a light intensity profile from the isolated pattern image thus picked up. Based on the light intensity profile generated from the isolated pattern image, the pattern inspection apparatus 7 measure the line width of the isolated pattern. Also, the pattern inspection apparatus 7 images an L/S pattern formed as a repeated pattern in which a convex pattern and concave pattern are repeated on the semiconductor wafer 100 in a predetermined cycle and generates a light intensity profile from the L/S pattern image thus picked up. Based on the light intensity profile thus generated from the L/S pattern image, the pattern inspection apparatus 7 measures the line width of the L/S pattern. Further, the pattern inspection apparatus 7 measures the accuracy of registration of the isolated pattern on an isolation pattern formed as a primary layer of the isolated pattern, diameter and depth of a content hole, etc.

The results of measurements are a guide for judging whether the resist pattern has properly been formed on the semiconductor wafer 100 in the semiconductor production line 1. That is, in the semiconductor production line 1, it is judged based on the results of measurements made by the pattern inspection apparatus 7 whether the resist pattern formed on the semiconductor wafer 100 is acceptable or rejectable. Only a semiconductor wafer 100 having formed thereon the resist pattern having been judged to be acceptable is fed to a next process, while a semiconductor wafer 100 whose resist pattern has been judged to be rejectable is sent to a resist reforming process.

Furthermore, the pattern inspection apparatus 7 inspects also distortion in the exposure apparatus 4, magnification factor, image field curvature and image field inclination in addition to the aforementioned measurement of line widths. These inspections are required for correction of the exposure in the exposure apparatus 4, and the results of inspection are supplied along with the results of isolated and L/S pattern line width measurements to a corrective information generator 33 which generates corrective information intended for use to correct the exposure in the exposure apparatus 4.

Based on the results of measurements and results of inspections, supplied from the image processing computer 31, the corrective information generator 33 generates various corrective information including information intended for use to correct the amount of exposure light in the exposure apparatus 4, information to correct the exposure focus position in the exposure apparatus 4, information to correct the aberration of the projection lens included in the exposure apparatus 4, and information to correct the image field curvature and inclination in the exposure apparatus 4. The corrective information generator 33 supplies these corrective information to the exposure apparatus 4.

More particularly, in the pattern inspection apparatus 7, both the line widths of an isolated pattern and L/S pattern formed on the semiconductor wafer 100 are measured and supplied to the corrective information generator 33. In the pattern inspection apparatus 7, the corrective information generator 33 separates exposure condition error information obtained from a deviation of a set isolated pattern line width from a predetermined one (isolated pattern line width error) and a deviation of a set L/S pattern line width from a predetermined one (L/S pattern line width error) into an error component of the amount of exposure light in the exposure apparatus 4 and an error component of the exposure focus position in the exposure apparatus 4, to thereby generate light-amount corrective information intended for use to correct the amount of exposure light in the exposure apparatus 4 and focus corrective information intended for use to correct the exposure focus position in the exposure apparatus 4.

As having been described in the foregoing, in the semiconductor production line 1, all the supplied semiconductor wafers 100 are inspected by the pattern inspection apparatus 7, and various kinds of corrective information generated by the corrective information generator 33 included in the pattern inspection apparatus 7 are fed back to the exposure apparatus 4. The exposure in the exposure apparatus 4 is corrected in real time correspondingly to the corrective information to control the exposure apparatus 4. More specifically, in this semiconductor production line 1, the amount of exposure time and exposure focus position, being the most important causes of the variation in determination of the exposure in the exposure apparatus 4, will be corrected in real time correspondingly to the corrective information from the pattern inspection apparatus 7. Therefore, the lithography in the semiconductor production line 1 makes it possible to considerably reduce the occurrence of rejectable semiconductor wafers.

Now, an example of the generation, in the pattern inspection apparatus 4, of corrective information intended for use to correct the exposure in the exposure apparatus 4 will be described in detail.

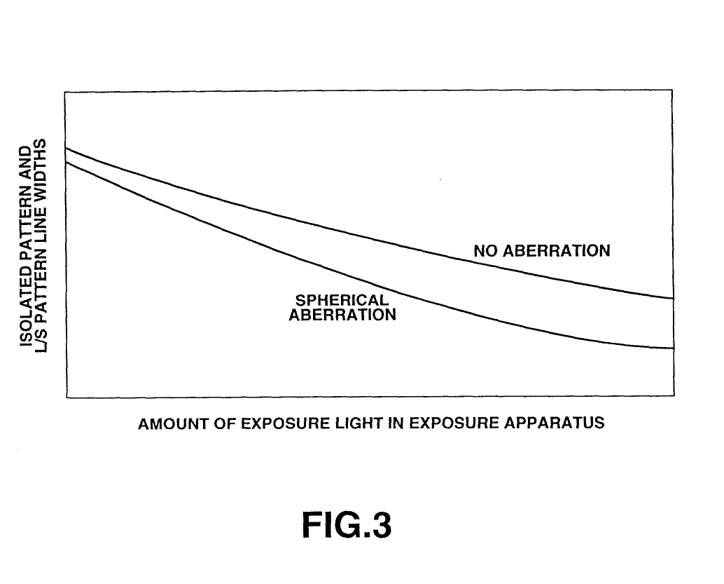

FIG. 3 shows the relation between amount of exposure light in the exposure apparatus 4 and line widths of an isolated pattern and L/S pattern formed on the semiconductor wafer 100. As seen from FIG. 3, the larger the amount of exposure light in the exposure apparatus 4, the smaller the line widths of isolated and L/S patterns formed on the semiconductor wafer 100 be, and a spherical aberration makes this tendency more remarkable.

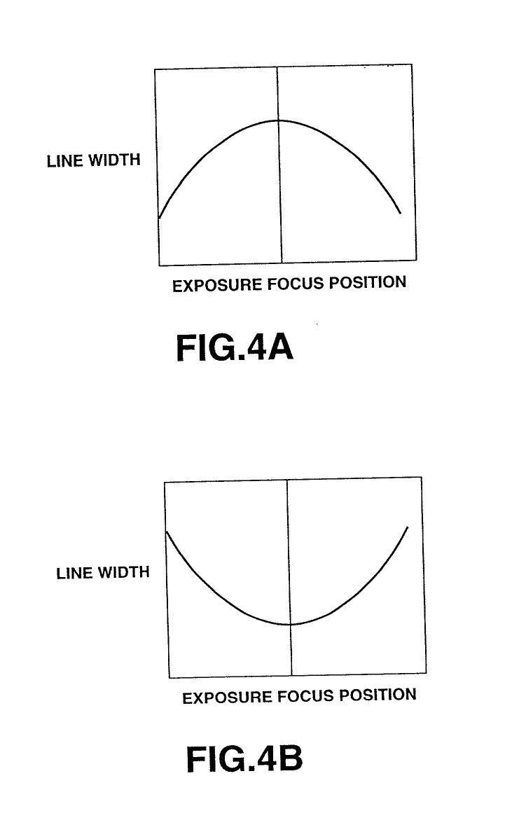

FIG. 4 shows the relations between exposure focus position in the exposure apparatus 4 and line widths of the isolated and L/S patterns formed on the semiconductor wafer 100. As seen from FIGS. 4A and 4B, the line width is different between the isolated and L/S patterns depending upon a variation of the exposure focus position in the exposure apparatus 4. That is, the isolated pattern has a smaller line width as the exposure focus position in the exposure apparatus 4 is farther from the focus as seen from FIG. 4A. On the other hand, the line width of the L/S pattern becomes larger as the exposure position in the exposure apparatus 4 is farther from the focus as seen from FIG. 4B. Further, it is known that the symmetry with respect to the defocused direction depends upon a spherical aberration among others in both the isolated and L/S patterns.

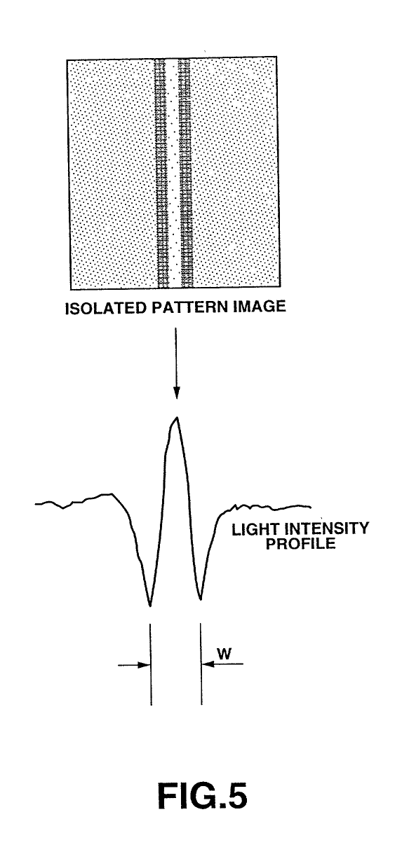

In the aforementioned pattern inspection apparatus 7, the line width of the isolated pattern is observed as a dip interval W in a light intensity profile prepared from the isolated pattern image as shown in FIG. 5.

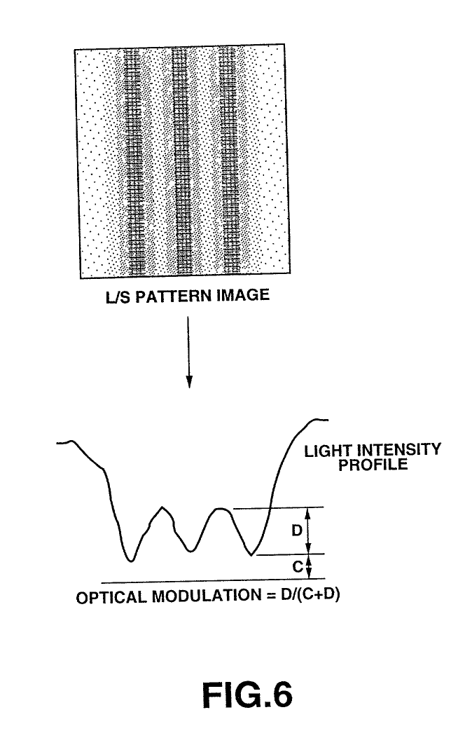

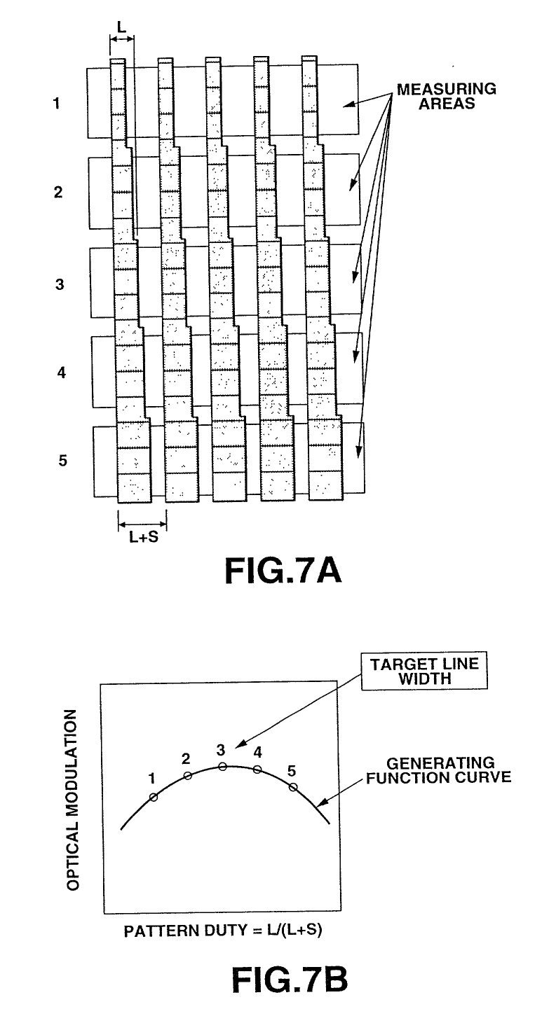

On the other hand, the L/S pattern can be observed as an image optically modulated as shown in FIG. 6. Note that in FIG. 6, the optical modulation is represented by D/(C+D). The line width of the L/S pattern can be dealt as a pattern duty in the same spatial frequency band as shown in FIG. 7A and the optical modulation can be dealt as a function of the pattern duty as shown in FIG. 7B. Note that the pattern duty is a ratio of L (line) width to a pattern width in one cycle consisting of L (line) and S (space).

Since the aforementioned pattern inspection apparatus 7 uses a laser source which emits highly coherent laser light as the illumination light source 13, the optical modulation of the L/S pattern under observation is extremely higher than observed in a pattern inspection apparatus in which for example a lamp or the like is used as the illumination light source.

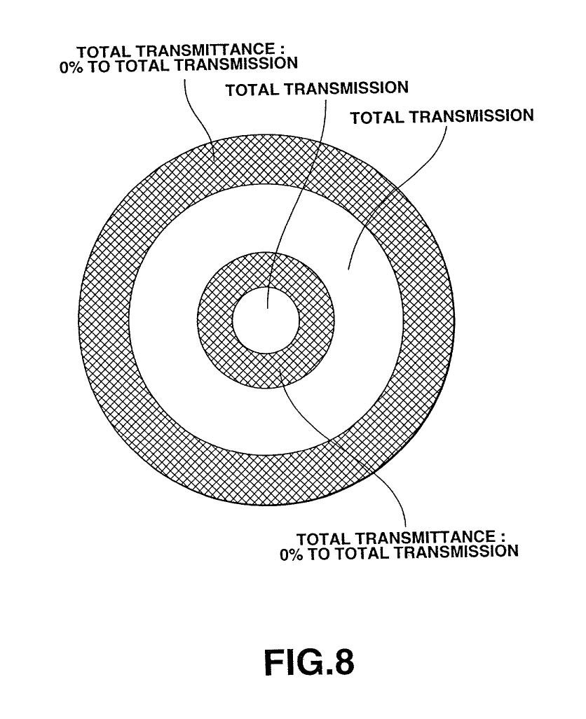

Further, in the pattern inspection apparatus 7, a spatial filer diaphragm intended to provide a deformed illumination as shown in FIG. 8 for example should desirably be provided at the aperture stop 12 in order to further improve the optical modulation of the L/S pattern under observation. By providing such a spatial filter diaphragm and providing an optimum deformed illumination correspondingly to an L/S pattern under observation, diffracted light of a higher order than second can be inhibited from taking place, and thus the optical modulation will be improved. It should be noted that the spatial filter diaphragm for a deformed illumination may not be shaped in any limited form but may be shaped in any form which could inhibit diffracted light of a higher order than second, depending upon the L/S pattern under inspection, from taking place. Also, since any diffracted light of a higher order than fourth will not contribute to imaging so much, it may not be cut as necessary in order to assure a sufficient amount of illumination light.

The optical modulation obtained during measurement of the line width of the L/S pattern takes an extreme at a predetermined pattern duty as shown in FIG. 7B. So, no L/S pattern line width before and after the extreme can be determined from the thus obtained optical modulation data. For this reason, in the semiconductor production line 1 adopting the exposure apparatus control system according to the present invention, inspection patterns each having a pattern duty varied by a step width and number of steps required to judge the extreme within the same measurement pattern are formed on the semiconductor pattern 100, the plurality of inspection patterns is measured by the pattern inspection apparatus 7, and a pattern matching of the measured data is made with a generating function curve shown in FIG. 7B to enable the measurement of the L/S pattern line width.

Note that the inspection pattern formed on the semiconductor wafer 100 is not limited to a shape shown in FIG. 7A but may be shaped in any form in which the spatial frequency, that is, a pattern width for one cycle, consisting of L (line) and S (space) is fixed with the line width, that is, L (line) width being varied. Further, a vertical pattern and horizontal pattern may be formed in a single inspection pattern.

In the above embodiment, the line width is measured with the spatial frequency being fixed. However, note that the line width of L/S pattern may be measured by measuring it with an inspection pattern in which the line width is fixed while the spatial frequency of the L/S pattern is varied and matching it with an optical modulation curve.

In the foregoing, the L/S pattern line width is defined by an algorithm in which the L/S pattern line width is measured based on the optical modulation taking in consideration the fact that the pattern duty at the same spatial frequency, namely, the line width of an L/S pattern, is a parameter on which the optical modulation depends. However, it should be noted that the magnification factor of the pattern inspection apparatus 7 may be elevated to determine an actual line width of L (line) from a light intensity profile prepared from an L/S pattern image and the actual line width may be taken as the L/S pattern line width.

In the semiconductor production line 1 incorporating the exposure apparatus control system according to the present invention, the spatial frequency of an L/S pattern to be measured by the pattern inspection apparatus 7 should desirably be measured properly under a design rule in a lithography going to be done. In this semiconductor production line 1, a target line width under measurement is determined for each lithography to measure the L/S pattern line width and isolated pattern line width of the target line width. The target line width should conveniently be determined for a semiconductor circuit pattern design rule, gate line width, critical process or a non-critical process. For a maximum optical modulation, the target line width for the L/S pattern is such that the pattern duty on a reticle mask is 50%, which is intended to assure a higher accuracy of fitting with the generating function curve shown in FIG. 7B.

In the pattern inspection apparatus 7, a deviation from a reference line width (line width error) is depicted for each of the isolated and L/S patterns based on line widths of the isolated and L/S patterns, measured as in the above, and focus position information obtained incidentally to these measurements, and it is matched with a pre-measured exposure focus position/line width curve shown in FIGS. 4A and 4B, thereby calculating an exposure focus position error, namely, a defocused amount, in the exposure apparatus 4 when the isolated and L/S patterns are formed. However, the above is not sufficient for judgement of the defocused direction.

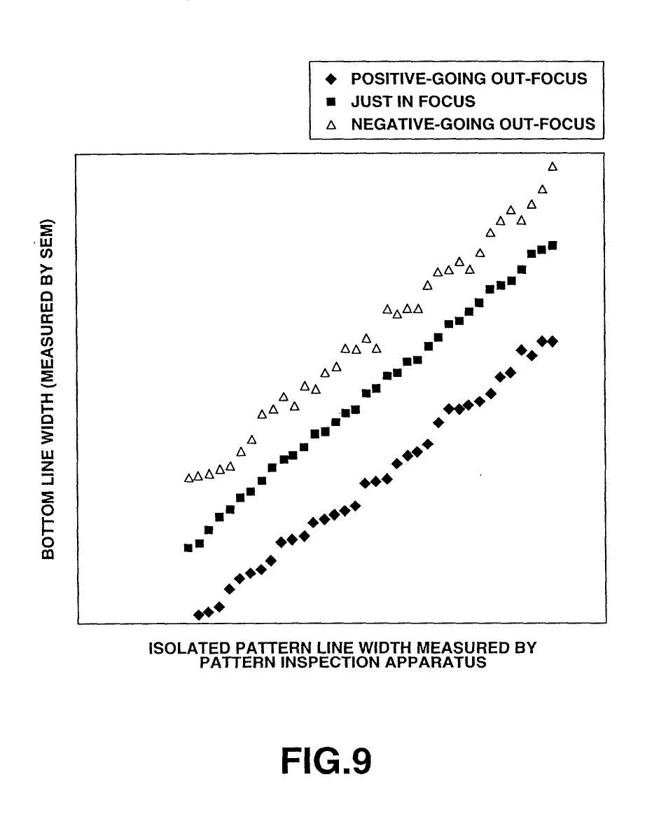

It should be noted that as will be seen from FIG. 9, the isolated pattern formed on the semiconductor wafer 100 will have a line width varied, as measured by the pattern inspection apparatus 7, due to a change or the like of the resist shape caused by a defocusing during exposure to the laser light even when the bottom line width (line width at the bottom of the pattern) is constant. That is, even when the bottom line width is constant, the isolated pattern line width measured by the pattern inspection apparatus 7 will be larger than when the laser light is just in focus if the exposure focus position in the exposure apparatus 4 is deviated in the plus (positive) going direction. On the other hand, if the exposure focus position in the exposure apparatus 4 is deviated in the minus (negative) going direction, the isolated pattern line width measured by the pattern inspection apparatus 7 will be smaller than when the laser light is just in focus. Note that the bottom line width shown in FIG. 9 is a value measured by the SEM (scanning electron microscope).

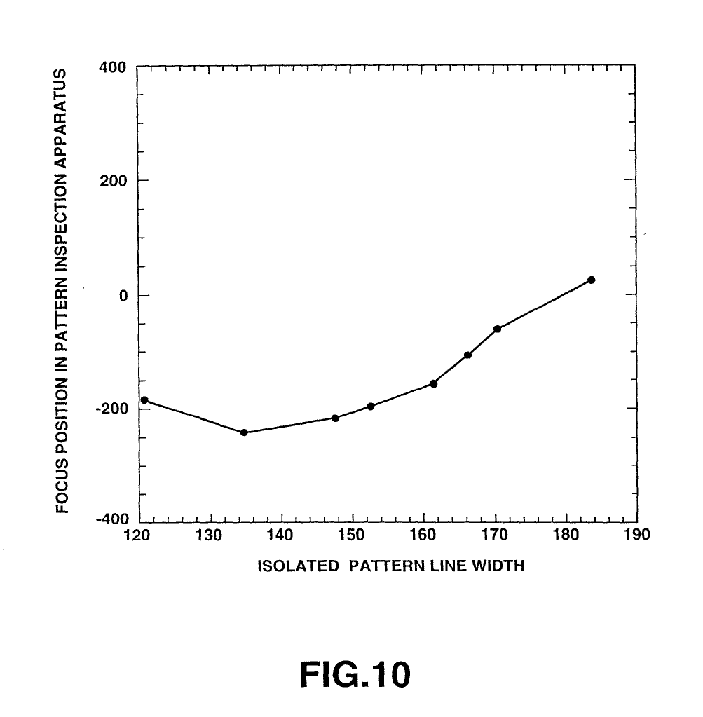

For a higher-accuracy measurement of the isolated pattern line width by the use of the pattern inspection apparatus 7, it is very effective to defocus the laser light in the imaging optical system and measure the isolated pattern line width based on a diffracted interference image of the isolated pattern, picked up by the imaging element 14 (off-focus interference method). In this case, the focus position in the pattern inspection apparatus 7, at which the best contrast point of the diffracted interference image of the isolated pattern can be obtained, will vary depending upon the isolated pattern line width as shown in FIG. 10 under the influence of an aberration of the optical system in the pattern inspection apparatus 7. The isolated pattern line width will be ruled by the bottom line width.

On the other hand, it is when the optical modulation used as a feature is maximum in measurement of the L/S pattern line width that the laser light is just in focus in the pattern inspection apparatus 7. That is, the bottom line width can be determined when it is possible to determine a difference between the focus position in the pattern inspection apparatus 7, at which the best contrast point of the diffracted interference image of the isolated pattern can be obtained when the aforementioned off-focus interference method is adopted, and the just-in-focus position in the pattern inspection apparatus 7, at which the optical modulation is maximum when the L/S pattern line width is measured.

As will be apparent from the above, the parameters obtained through the line width measurement by the pattern inspection apparatus 7 include three: isolated pattern line width, L/S pattern line width and bottom line width, which depends the pattern form. By matching these three parameters with patterns shown in FIGS. 4A, 4B, 7B, 9 and 10, it is possible to recognize the defocused amount and direction in the exposure apparatus 4, and to calculate line widths of the isolated and L/S patterns, which are free from the influence of a defocusing, namely, which are assumed to have been exposed just in focus to the laser light.

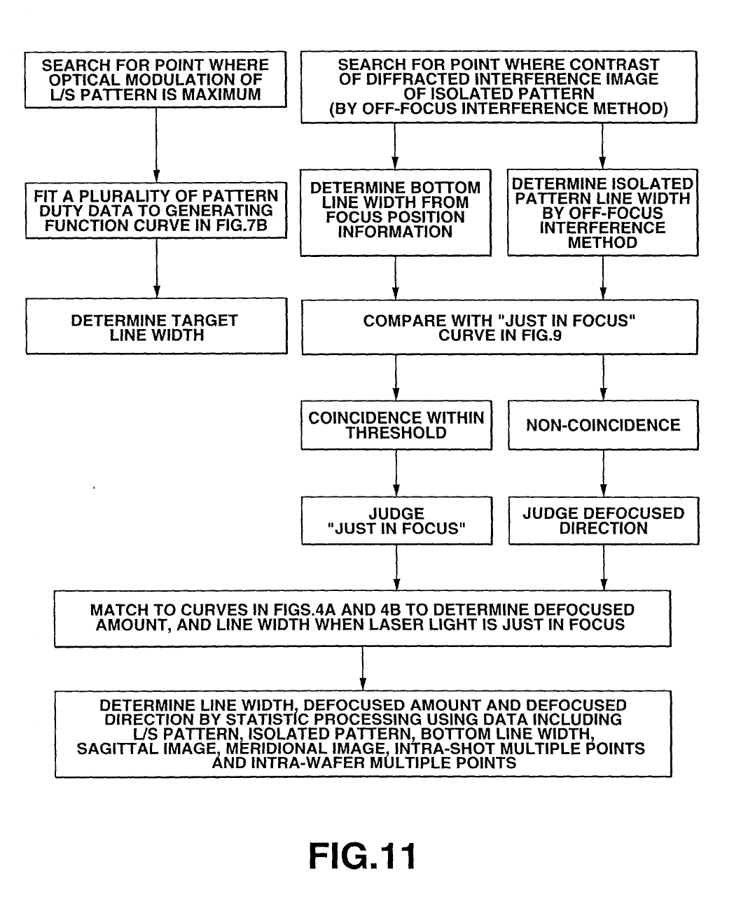

Referring now to FIG. 11, there is shown an algorithm by which line widths of the L/S and isolated patterns, defocused amount and direction in the exposure apparatus 4 are determined by the pattern inspection apparatus 7 based on the aforementioned principle of measurement. The measurement algorithm shown in FIG. 11 has been realized by taking in consideration that the frequency response for each line width will be changed by an optical aberration of such an extent as will not adversely affect the measurement is imparted to the optical system in the pattern inspection apparatus 7. By determining a defocused amount and direction in the exposure apparatus 4 by the use of this algorithm, it is possible to separate an error component of the exposure focus position from the exposure condition error information of the exposure apparatus 4, obtainable from errors of an isolated and L/S pattern line widths.

By making a pattern matching with the line width vs. exposure light amount curve shown in FIG. 3 after having separated the error component of the exposure focus position in the exposure apparatus 4, it is possible to determine an error of amount of exposure light in the exposure apparatus 4.

In the pattern inspection apparatus 7, the above operations are effected by the image processing computer 31 and corrective information generator 33 to determine errors of exposure focus position and amount of exposure light in the exposure apparatus 4, thereby generating focus corrective information intended for use to correct the exposure focus position in the exposure apparatus 4 and light-amount corrective information intended for use to correct the amount of exposure light. The focus corrective information and light-amount corrective information are fed back to the exposure apparatus 4 to properly control the latter. Thus, the amount of exposure light and exposure focus position, which are most important in determination of the exposure in the exposure apparatus 4, will be corrected in real time correspondingly to the corrective information from the pattern inspection apparatus 7, whereby it is possible to considerably reduce the occurrence of rejectable wafers.

Also, in the pattern inspection apparatus 7, measurement of at least one of the aforementioned isolated and L/S pattern line widths is done with both a sagittal and meridional images in order to improve the accuracy of measurement and correct the aberration in the exposure apparatus 4. If the result of measurement differs from the sagittal image to the meridional image, it means that an aberration has taken place in the projection lens included in the exposure apparatus 4. In this case, the pattern inspection apparatus 7 generates aberration corrective information intended for use to correct the aberration of the projection lens and feed back the information to the exposure apparatus 4.

Further, in the pattern inspection apparatus 7, measurement of at least one of the aforementioned isolated and L/S pattern line widths is done at a plurality of positions inside a predetermined exposure field on the semiconductor wafer 100 in order to correct the image field curvature and inclination in the exposure apparatus 4. That is, the previously mentioned inspection patterns are provided at the plurality of positions, respectively, inside the predetermined exposure field on the semiconductor wafer 100, and these inspection patterns are measured by the pattern inspection apparatus 7. Thus, it is possible to know an optimum image field position inside the predetermined exposure field, that is, an image field curvature and inclination in the exposure apparatus 4, and also a nonuniformity of the amount of exposure light in the exposure field. The pattern inspection apparatus 7 generates, based on the information on the thus obtained optimum image field position, image field corrective information intended for use to correct the image field curvature and inclination in the exposure apparatus 4 and nonuniformity of the amount of exposure light, and feeds these corrective information to the exposure apparatus 4.

In the above pattern inspection apparatus 7, the number of L (line) of the L/S pattern is set to three or five and an optical modulation is determined by averaging. However, it should be noted that the number of lines (L) in the L/S pattern is not limited to three or five but may properly be set based on a desired accuracy and tact time of measurement. Since the accuracy of measurement can be improved by increasing the number of L (line) in the L/S pattern, the latter should desirably be set to a possible larger number within the allowable range of the measuring tact time.

It is well known that when the optical system of the exposure apparatus 4 incurs a coma, the line width of the L/S pattern differs from the left end to right end. This can be observed as a difference in the optical modulation in the above pattern inspection apparatus 7 as well. Therefore, in the pattern inspection apparatus 7, a coma in the optical system of the exposure apparatus 4 can be found through processing of data at the left and right ends of the L/S pattern line width, and when any coma abnormality is detected, corrective information for use to correct the abnormality can be fed back to the exposure apparatus 4.

It is also well known that if the optical system in the exposure apparatus 4 incurs a spherical aberration, the focus position varies for each exposure line width. Therefore, a spherical aberration of the exposure apparatus 4 can be found through forming of an inspection pattern as shown in FIG. 7A on the semiconductor wafer 100, simultaneous measurement of different line widths of the inspection pattern by the pattern inspection apparatus 7 and processing of data according to an algorithm for measurement of a defocused amount in the above exposure apparatus 4, and when any aberration abnormality is detected, corrective information for use to correct the aberration abnormality can be fed back to the exposure apparatus 4.

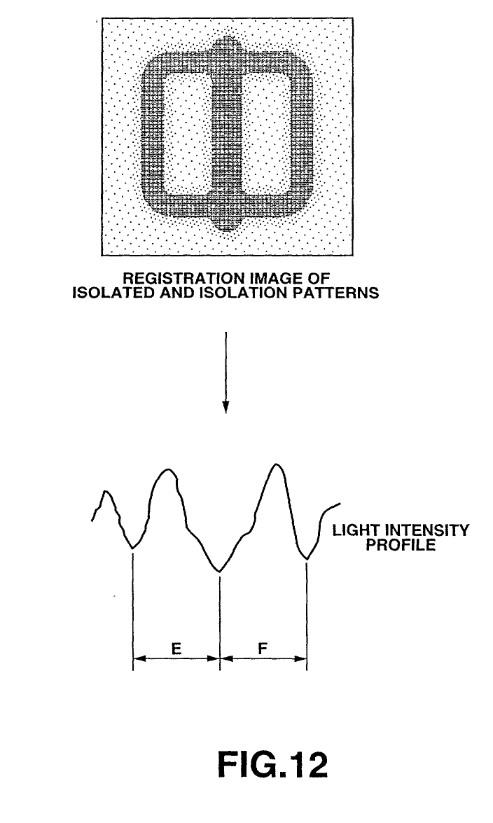

Further, the pattern inspection apparatus 7 makes an inspection of the accuracy of registration of the isolated pattern and an isolation pattern formed as the primary layer of the isolated pattern one on the other, distortion inspection and magnification factor inspection, the latter two being applications of the registration accuracy inspection, in addition to the above-mentioned measurement of the isolated and L/S pattern line widths. In this case, spacings E and F between the right and left ends of the isolated and isolation patterns, respectively, are measured in two directions perpendicular to each other on the basis of an image of the isolated and isolation patterns registered one on the other, as shown in FIG. 12. Thus, the accuracy of registration of the isolated pattern on the isolation pattern is inspected. By inspecting the registration accuracy at a plurality of points within the exposure field in the exposure apparatus 4, it is possible to inspect a distortion and magnification factor relative to a preceding exposure process within the exposure field. As in the above, in the pattern inspection apparatus 7, the registration accuracy, distortion and magnification factor are inspected, and when an abnormality is found in any of them, corrective information for use to correct the abnormality is fed back to the exposure apparatus 4.

In the semiconductor production line 1 in which the exposure apparatus control system according to the present invention is applied, exposure by the exposure apparatus 4 is followed by development by the developer 5, post-baking by the heater 6 and then by inspection by the pattern inspection apparatus 7 as having been described in the foregoing. Therefore, in the feedback loop from the pattern inspection apparatus 7 to the exposure apparatus 4, there exist some time constant which will cause a phase lag. Thus, the first purpose of the feedback from the pattern inspection apparatus 7 to the exposure apparatus 4 is to know a trend of the above variation for updating the fed-back parameters for each semiconductor wafer 100 having been inspected.

In the pattern inspection apparatus 7, noise component is reduced to (1/N) ^{½} for an improved accuracy of measurement by averaging it by a number of measuring points N in the semiconductor wafer 100. Therefore, the updating the parameters fed back from the pattern inspection apparatus 7 to the exposure apparatus 4 for each semiconductor wafer 100 having been inspected is very effective for such an improved accuracy of measurement, and is most suitable for the exposure apparatus control system used in the semiconductor production line 1.

As having been described in the foregoing, the pattern inspection apparatus according to the present invention can properly inspect a deviation of the amount of exposure light and deviation of the exposure focus position in the exposure apparatus used in the lithography effected in the semiconductor production process to generate light-amount corrective information intended for use to correct the amount of exposure light in the exposure apparatus and focus corrective information intended for use to correct the exposure focus position, and feed the corrective information back to the exposure apparatus.

Also, the exposure apparatus control system according to the present invention can make a proper and real-time correction of an amount of exposure light and exposure focus position in the exposure apparatus used in the lithography effected in the semiconductor production process, correspondingly to light-amount corrective information and focus corrective information generated by the pattern inspection apparatus. Therefore, the exposure apparatus control system can considerably reduce the occurrence of rejectable wafers in the lithography, and thus improve the yield of the semiconductor production.

What is claimed is:

1. A pattern inspection apparatus which optically inspect a resist pattern formed on a semiconductor wafer correspondingly to the pattern of a semiconductor circuit going to be produced, the apparatus comprising:
means for measuring at least both the line width of an isolated pattern being a convex pattern and that of a repeated pattern in which a convex pattern and concave one are repeated in a predetermined cycle; and
means for generating corrective information intended for use to correct the exposure by an exposure apparatus used to form the resist pattern on the basis of the line width of the isolated pattern and that of the repeated pattern, having been measured by the above measuring means;
the corrective information generating means separating exposure condition error information of the exposure apparatus, obtained from a line width error of the isolated pattern and that of the repeated pattern, into an light-amount error component and an exposure focus position error component to generate light-amount corrective information intended for use to correct the amount of light and focus corrective information intended for use to correct the exposure focus position.

2. The apparatus according to claim 1, wherein:
the measuring means measures at least one of the line width of the isolated pattern and that of the repeated pattern on the basis of both a sagittal image and meridional image; and
the corrective information generating means generates aberration corrective information intended for use to correct aberration of a projection lens included in the exposure apparatus on the basis of the result of the measurement made based on the sagittal and meridional images by the measuring means.

3. The apparatus according to claim 1, wherein:
the measuring means measures at least one of the line width of the isolated pattern and that of the repeated pattern at a plurality of positions on the semiconductor wafer; and
the corrective information generating means generates image field corrective information intended for use to correct image field curvature and image field inclination of the exposure apparatus on the basis of the result of the measurement made at the plurality of positions by the measuring means.

4. The apparatus according to claim 1, wherein the measuring means comprises an ultraviolet laser source which emits an ultraviolet laser light of 150 to 370 nm in wavelength as a light source intended to optically measure the line width of the isolated pattern and that of the repeated pattern.

5. The apparatus according to claim 4, wherein the measuring means includes means for controlling the amount of the ultraviolet laser light emitted from the ultraviolet laser source to a one which will not cause any shrink in the isolated and repeated patterns.

6. The apparatus according to claim 1, wherein the measuring means measures a degree of optical modulation of the repeated pattern and measures the line width of the repeated pattern based on the result of the optical modulation measurement.

7. The apparatus according to claim 1, wherein the measuring apparatus also measures an error in registration of the isolated pattern with an isolation pattern formed as a primary layer of the isolated pattern.

8. An exposure apparatus control system comprising:
an exposure apparatus used to form a resist pattern on a semiconductor wafer correspondingly to a pattern of a semiconductor circuit going to be produced; and
a pattern inspecting apparatus to optically inspect the resist pattern formed on the semiconductor wafer by the exposure apparatus;
the pattern inspection apparatus comprising:
means for measuring at least both the line width of an isolated pattern being a convex pattern and that of a repeated pattern in which a convex pattern and concave one are repeated in a predetermined cycle; and
means for generating corrective information intended for use to correct the exposure by an exposure apparatus used to form the resist pattern on the basis of the line width of the isolated pattern and that of the repeated pattern, having been measured by the above measuring means;
the corrective information generating means separating exposure condition error information of the exposure apparatus, obtained from a line width error of the isolated pattern and that of the repeated pattern, into an light-amount error component and an exposure focus position error component to generate light-amount corrective information intended for use to correct the amount of light and focus corrective information intended for use to correct the exposure focus position; and
in the exposure apparatus, the amount of light being corrected correspondingly to the light-amount corrective information generated by the corrective information generating means included in the pattern inspection apparatus, and the exposure focus position being corrected correspondingly to the focus corrective information generated by the corrective information generating means included in the pattern inspection apparatus.

9. The system according to claim 8, wherein:
the measuring means included in the pattern inspection apparatus measures at least one of the line width of the isolated pattern and that of the repeated pattern on the basis of both a sagittal image and meridional image;
the corrective information generating means included in the pattern inspection apparatus generates aberration corrective information intended for use to correct aberration of a projection lens included in the exposure apparatus on the basis of the result of the measurement made based on the sagittal and meridional images by the measuring means; and
in the exposure apparatus, aberration of the projection lens is corrected correspondingly to the aberration corrective information generated by the corrective information generation means included in the pattern inspection apparatus.

10. The system according to claim 8, wherein:
the measuring means included in the pattern inspection apparatus measures at least one of the line width of the isolated pattern and that of the repeated pattern at a plurality of positions on the semiconductor wafer;
the corrective information generating means included in the pattern inspection apparatus generates image field corrective information intended for use to correct image field curvature and image field inclination of the exposure apparatus on the basis of the result of the measurement made on the plurality of positions by the measuring means; and
in the exposure apparatus, image field curvature and image field inclination are corrected correspondingly to the image field corrective information generated by the corrective information generating means included in the pattern inspection apparatus.
